(19) United States
(12) Patent Application Publication
(10) Pub. No.: US 2005/0043042 A1
(43) Pub. Date: Feb. 24, 2005

(54) Location caller identification information method and apparatus

(76) Inventors: Kuen-Yih Hwang, Naperville, IL (US); Robert A. Sherry, Aurora, IL (US)

Correspondence Address: SHERIDAN ROSS PC, 1560 BROADWAY, SUITE 1200, DENVER, CO, 80202, US

(21) Appl. No.: 10/687,728

(22) Filed: Oct. 16, 2003

Related U.S. Application Data
(60) Provisional application No. 60/443,987, filed on Jan. 30, 2003.

(51) Int. Cl. H04Q 7/20

(52) U.S. Cl. 455/456.2; 455/456.1

(57) ABSTRACT

The present invention is related to the provision of location related information regarding a communication device. Such location related information may be provided in response to a request for such information made in connection with an individual request, or in response to a pre-provisioned request for such information. The present invention is capable of providing location related information even when communication devices are on disparate networks, and when communication devices are roaming. The present invention further provides for the validation of requests for location related information.

### CROSS REFERENCE TO RELATED APPLICATIONS

This application claims the benefit of U.S. Provisional Patent Application No. 60/443,987, filed Jan. 30, 2003, entitled “LOCATION CALLER IDENTIFICATION INFORMATION,” which is incorporated by reference herein in its entirety.

### FIELD OF THE INVENTION

The present invention is directed to providing location information concerning a communication device. In particular, the present invention provides the location or information related to the location of a communication device to that communication device or to another communication device.

### BACKGROUND OF THE INVENTION

Communication devices that allow parties remote from one another to communicate have become ubiquitous in contemporary society. In addition, many communication devices are not fixed to any particular geographic location. For example, mobile telephones capable of operating in connection with different network types can be used in different regions of a country, or even different countries, while retaining a unique identifier. Although voice telephony devices remain the most commonly used means for enabling remote communications, textual or other data may also be transmitted between communication devices. Furthermore, devices primarily devoted to voice telephony functions may be used in connection with other forms of communication. Such other forms of communication may be transmitted as in-band (with respect to voice communications) or out of band data. Furthermore, devices providing no or limited voice communication functions, including mobile computing devices such as laptop computers and personal digital assistants, may be used.

In addition to assertions made by a communicant participating in a communication, systems have been developed that automatically provide information regarding one communication device to another. For example, caller identification (caller I.D.) data, which provide the telephone number and the name of the account holder related to a communication device are available to called parties in conventional voice telephony networks. Similarly, in connection with text messaging, the sender's return address is typically included. However, such systems have not provided information regarding the geographical location of a party to a communication to another party to that communication. Furthermore, communication devices capable of enabling communications across communication networks have not provided location information to the user of the device.

In the field of emergency communication services, systems capable of delivering information regarding the location of a calling party to a public safety answering point have been developed. However, such systems only function to provide location information concerning a calling party when such party has initiated contact with a public safety answering point. Furthermore, because such systems have been developed in support of providing emergency services, privacy concerns regarding the location of the calling party have not been addressed.

### SUMMARY OF THE INVENTION

The present invention is directed to solving these and other problems and disadvantages of the prior art.

In accordance with an embodiment of the present invention, location related information concerning a party to a communication is provided to another party to that communication. Location related information may be provided to one, some, or all of the participants in a communication, including a calling party and a called party. The location related information may include the geographic location of a party expressed, for example, as a latitude and longitude, or a street address. Location related information may also include information derived from the geographic location of the party, such as a map of the area surrounding that party, current weather conditions at the party's location, and information regarding services in the area of the party.

In accordance with an embodiment of the present invention, location related information associated with a communication device is provided in response to a validated request for such information. In particular, a location determining entity may be queried for the requested location related information in response to a validated request, and the requested information may be provided to the requesting device. The information provided to the requesting device may include the location of the requesting device or of another device (referred to herein as location information), or information derived from the location of the requesting device or the other device. In general, as used herein, location related information includes location information and information derived from such location information.

In accordance with another embodiment of the present invention, a request for location related information associated with a communication device is received at a location service center. The location service center may comprise a node on a communication network. The request for location related information may be generated automatically, for example as a network trigger encountered when a call is placed from a first communication device to a second communication device. Alternatively, the request for information may be received as a communication link is established between the requesting device and the location service center.

In accordance with still another embodiment of the present invention, validation of a request for location related information comprises accessing stored information to determine whether permission has been granted by an account holder of a device to provide location related information associated with that device to a particular requesting device. Accordingly, embodiments of the present invention may limit the communication devices to which location related information is provided. In accordance with still another embodiment of the present invention, a user of a communication device may grant permission to provide location related information associated with that device to another communication device on a case-by-case basis.

In accordance with embodiments of the present invention, requested location related information may be provided separately from a communication or a request for a communication link between communication devices. For example, a first communication device may place a request for location related information regarding a second communication device by contacting a location service center, independently of initiating a communication with the second communication device. Furthermore, various communication networks may be used to transmit data. For instance, a first communication network or set of networks may be used in connection with a communication between communication devices, and a second communication network or set of networks may be used to deliver requested location related information.

In accordance with still other embodiments of the present invention, multiple location service centers may be used in delivering requested information. In addition, a location service center may query multiple communication networks in connection with obtaining requested location related information. In accordance with embodiments of the present invention, a routing and inter-working function may be provided to facilitate the delivery of requested location related information between disparate communication networks.

Additional features and advantages of the present invention will become readily apparent from the following discussion, particularly when taken together with the accompanying drawings.

### BRIEF DESCRIPTION OF THE DRAWINGS

FIG. 1 depicts a communication system in accordance with an embodiment of the present invention;

FIG. 2 depicts a communication system in accordance with another embodiment of the present invention;

FIG. 3 depicts a communication system in accordance with another embodiment of the present invention;

FIG. 4 is a block diagram depicting components of a location service center in accordance with an embodiment of the present invention;

FIG. 5 is a flow diagram depicting the operation of an embodiment of the present invention;

FIG. 6 is a flow diagram depicting the operation of another embodiment of the present invention;

FIGS. 7A and 7B are flow diagrams depicting the operation of another embodiment of the present invention; and

FIGS. 8A and 8B are flow diagrams depicting the operation of another embodiment of the present invention.

### DETAILED DESCRIPTION

The present invention relates to the provision of location related information associated with a communication device to that communication device or to another communication device.

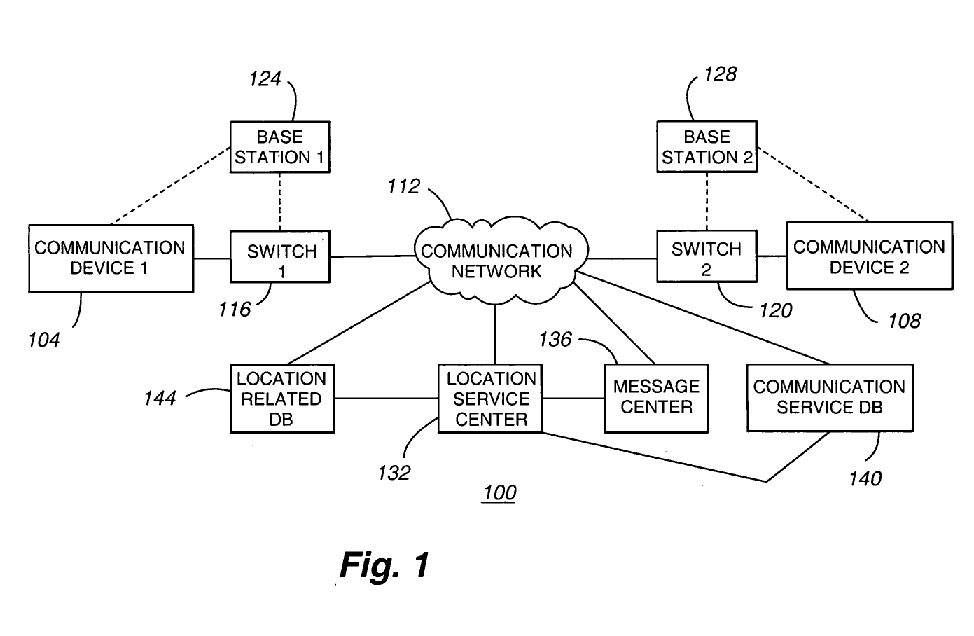

With reference now to FIG. 1, a communication system 100 in accordance with an embodiment of the present invention is illustrated. In general, the communication system 100 comprises a first communication device 104 and a second communication device 108. The first 104 and second 108 communication devices may include any device or combination of devices that may be used to place a user of the first device 104 in communication with a user of the second device 108 or with a network element. Accordingly, examples of communication devices 104, 108 include landline and wireless telephones, pagers, voice over Internet protocol (VOIP) hard or soft telephones, and computing devices, such as laptop computers or personal digital assistants having communication capabilities through wireline or wireless networks.

Each communication device 104, 108 is generally interconnected to a communication network 112 by a switch or switch center 116, 120. Alternatively, for example, where the respective communication device 104, 108 comprises a wireless device, such as a cellular telephone, a communication device 104, 108 may be interconnected to a corresponding switch 116, 120 through a base station 124, 128. As can be appreciated by one of skill in the art, a switch 116, 120 may comprise a switch or switch center provided as part of a public switched telephone network (PSTN), a private branch exchange (PBX), or a packet data network switch. In addition, a switch 116, 120 may be a part of a wireline and/or wireless network. Furthermore, a switch or switch center 116, 120 may be capable of generating trigger queries and responses, and acting on received trigger queries and responses. Such trigger queries may include requests for location related information, may deliver location related information, or may contain call set-up instructions, including whether a call is to be continued or disconnected.

The communication network 112 may comprise one or a number of interconnected networks. Furthermore, where the communication network 112 comprises a number of networks, those networks may be of different types, provided of course that they are suitably interfaced. The communication network 112 may comprise the public switched telephone network, a local area network (LAN), wide area network (WAN), and wireless communication networks.

Although shown as distinct from the communication network 112, it should be appreciated that the switches 116, 120 may be considered part of the communication network 112. For example, a first switch 116 comprising a telephone company end office may be considered a part of the communication network 112 comprising a public switched telephone network. As a further example, a second switch 120 comprising a mobile switching center may be considered a part of the communication network 112 comprising a wireless network.

The system 100 also generally includes a location service center 132. In general, the location service center 132 is in communication with various other of the components of the system 100, either through the communication network 112, or through a direct communication link. As will be described in greater detail herein, the location service center 132 is a trusted network element that generally functions to receive and process requests for location related information associated with a communication device or devices 104, 108. Accordingly, location information may be obtained by using a communication device 104, 108 to contact the location service center 132 directly. Alternatively, location related information may be requested by a network trigger encountered in connection with a request for a communication link between a first communication device 104 and a second communication device 108 that results in a request for location related information or a request for such information being provided to the location service center 132. Accordingly, the location service center 132 may be capable of acting on received trigger queries and responses and generating and sending trigger queries and responses to other network elements or nodes.

The location service center 132, as a trusted center or node in the communication network comprising the system 100, may consist of or have the capabilities of other trusted entities, such as gateway mobile location center (GMLC), mobile positioning center (MPC), visitor location register (VLR), mobile switching center (MSC), gateway mobile switching center (GMSC), home location register (HLR), service control function (SCF), service control function for GSM network (gsmSCF), etc. Such network entities may therefore be provided as part of the location service center 132 and may be implemented in a physical platform that is common to the location service center 132. In general, the network entities are used to interrogate the communication network 112 and nodes associated with such network, such as switches 116, 120 to obtain location related information based on different position quality of service levels.

In addition, the location service center 132 may function to transform location related information comprising location information into other location related information. For example, location information received as a latitude and longitude may be transformed into location related information comprising a street address. As further examples, location information regarding a communication device may be used to obtain a map of the area surrounding that location, services available in the area surrounding the location, current weather conditions at that location, or other information that may be derived from a location.

The network triggers that may be encountered in connection with the communication network 112 and switches 116, 120 may comprise intelligent network triggers. For example, the triggers may include wireless intelligent network (WIN) triggers, customized application for mobile network enhanced logic (CAMEL) triggers, intelligent network (IN) triggers, and other network triggers.

The location service center 132 may comprise or be associated with a message center 136. In general, the message center 136 may function to deliver requested location related information to an appropriate communication device 104, 108 in the required format. For example, in response to a request by the location service center 132, the message center 136 may direct the communication network 112 to send a textual short message to the requesting communication device 104, 108. Accordingly, the message center 136 may incorporate an Internet inter-working function to interface the location service center 132 to the Internet. Furthermore, it can be appreciated that the message center 136 may be interconnected to a different network within the communication network 112 than is the location service center 132 itself. For example, because the location service center 132 is typically implemented as a trusted network element, an interconnection with the public Internet and the location service center 132 may be through the message center 136. Accordingly, network triggers and location related information may be received by the location service center 132 through the message center 136 when such triggers or location related information is received from the Internet. Information provided by the location service center 132 that is to be delivered over certain communication networks 112 such as the Internet may be sent through the message center 136.

The system 100 may also include a communication service database 140. The communication service database 140 may provide information to enable the system 100 to relate a fixed communication device 104, 108 to a location. For example, the communication service database 140 may enable a location service center 132 to obtain a street address corresponding to the telephone number of a communication device 104, 108 for which location related information is requested. Accordingly, the communication service database 140 may comprise a white pages directory. The communication service database 140 may be generally connected to various other components of the system 100 through the communication network 112.

The system 100 may additionally include a location related database 144. The location related database 144 may be used to store information regarding location service subscriptions associated with a communication device 104, 108 and information regarding permissions granted by one communication device 104, 108 with respect to requests for that communication device's location related information placed by or through a second communication device (e.g. second communication device 108). The location related database 144 may also store information that may be returned as location related information in response to a request for location related information. Accordingly, data stored in the location related database 144 may include maps, service directories, links to other data, including real time data such as weather conditions, and other information.

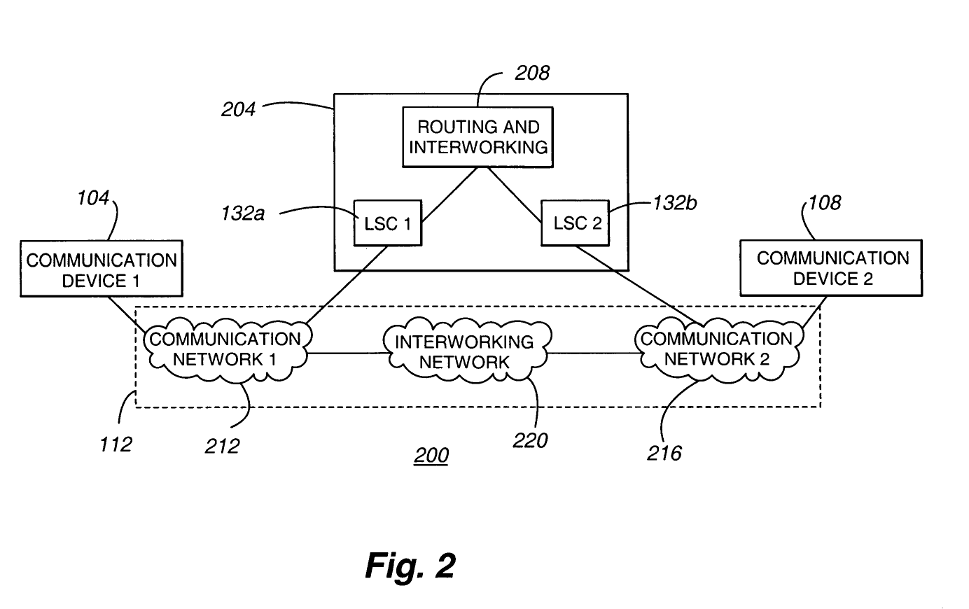

With reference now to FIG. 2, a communication system 200 in accordance with another embodiment of the present invention is illustrated. In general, the system 200 is similar to the system 100 of FIG. 1, in that it includes a first communication device 104 and a second communication device 108 interconnected to one another through a communication network 112. However, rather than a single location service center 132 as shown in FIG. 1, the system 200 of FIG. 2 includes a global location service center system 204 that includes a first location service center 132a and a second location service center 132b. In addition, the global location service center 204 includes a routing and inter-working function 208.

The first location service center 132a is interconnected to the communication network 112 at a first communication network 212. The second location service center 132b is interconnected to the communication network 112 at a second communication network 216. Accordingly, it can be appreciated that the communication network 112 of the embodiment of the present invention illustrated in FIG. 2 comprises at least first 212 and second 216 communication networks. The first 212 and second 216 communication networks may themselves comprise a number of networks of various types. The first 212 and second 216 communication networks may be interconnected to one another by an inter-working network 220. The inter-working network 220 may also comprise a number of networks of various types. Alternatively, the first communication network 212 may be directly interconnected to the second communication network 216.

The routing and inter-working function 208 generally functions to facilitate communications between the first 132a and second 132b location service centers. As will become more readily apparent from the further discussion provided herein, the system 200 illustrated in FIG. 2 has particular applicability in connection with the provision of location related information, even when the communication networks (e.g., networks 212 and 216) to which communication devices 104, 108 are connected are not in direct communication with one another, and/or are widely separated from one another.

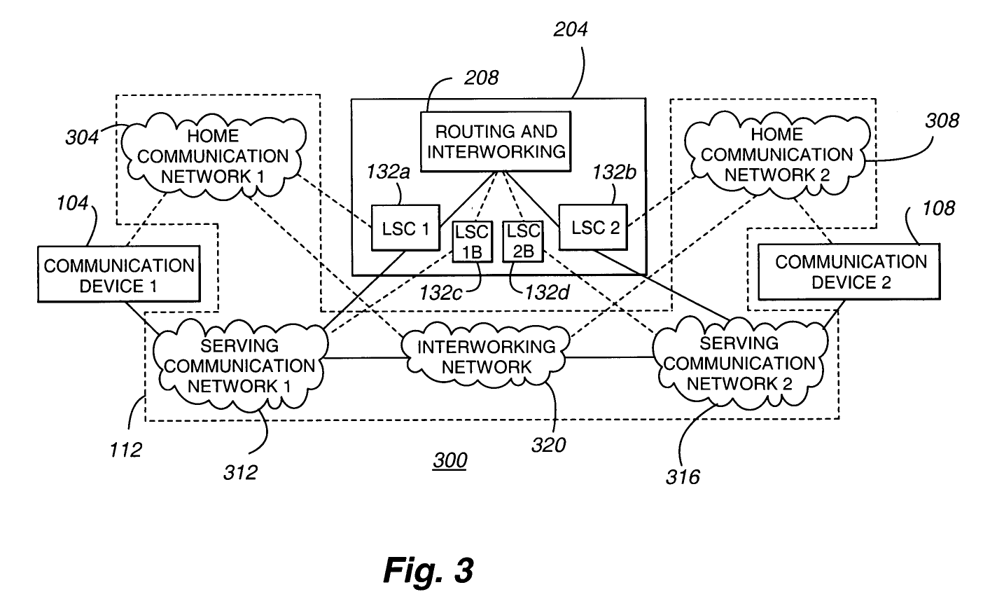

With reference now to FIG. 3, a communication system 300 in connection with still another embodiment of the present invention is illustrated. The system 300 generally includes first 104 and second 108 communication devices interconnected to one another through a communication network 112. In addition, the system 300 includes a global commercial location service center 204. As with the embodiment illustrated in FIG. 2, the global location service center 204 includes a first location service center 132a, a second location service center 132b, and a routing and inter-working function 208.

The system 300 illustrated in FIG. 3 differs from the system 200 in that the communication network 112 comprises a first home communication network 304, a second home communication network 308, a first serving communication network 312, and a second serving communication network 316. An inter-working network 320 may be provided to interconnect the various other networks of the communication network 112.

The embodiment of the present invention illustrated in connection with the system 300 of FIG. 3 is particularly useful in connection with understanding the operation of embodiments of the present invention when one or more communication devices 104, 108 are roaming. In particular, the system 300 illustrates components of embodiments of the present invention that are particularly adapted for providing location related information even when one or more communication devices 104, 108 are interconnected to a serving communication network 312, 316 rather than the home communication network 304, 308 of the communication device 104, 108.

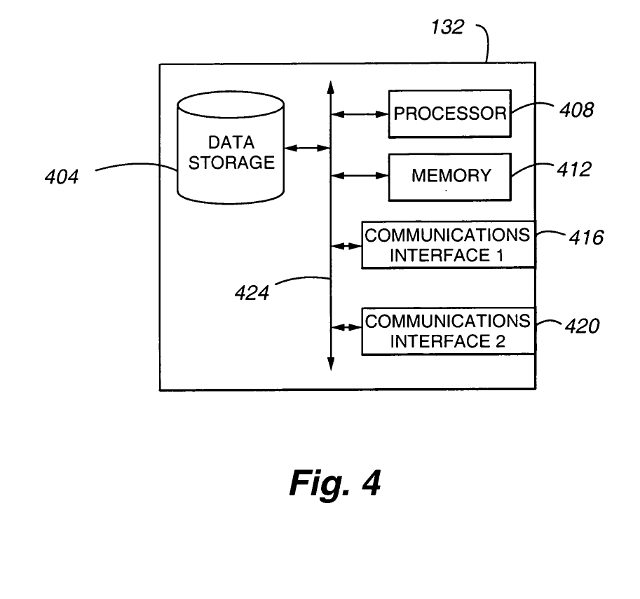

With reference now to FIG. 4, components of a location service center 132 in accordance with an embodiment of the present invention are illustrated. In general, a location service center 132 may comprise a general purpose or specially adapted computer, such as a telecommunications server. Accordingly, a location service center 132 may include data storage 404. The data storage 404 may be used to store operating system and application programming. In addition, the data storage 404 may comprise one or more databases. For example, a location related database 144 (see FIG. 1) may comprise data and associated application programming stored in data storage 404 provided as part of a location service center 132. In addition, the data storage 404 may be used to store subscription and other identifying and validating information so that requests for location information can be validated. The data storage may comprise any type of storage system, including magnetic, optical or solid state devices. In addition, such devices may be provided in any combination.

A processor 408 is provided for running the various programming and processing data, such as may be stored in data storage 404. The processor 408 may comprise a general purpose programmable processor, for example a PENTIUM, MOTOROLA 68000 or COMPAQ ALPHASERVER processor.

Memory 412 may be provided for use in connection with the execution of programming and processing of data by the processor 408. The memory 412 may comprise volatile or non-volatile memory, include DRAM, SDRAM and ROM.

The location service center 132 may also include a first communication network interface 416. The first communication interface 416 interfaces the location service center 132 to a communication network 112. Accordingly, the first communication interface 416 may comprise, for example, an SS7 interface. In addition, embodiments of a location service center 132 may comprise a second communication interface 420. For example, the second communication network interface 420 may serve to interface the location service center 132 to a packet data communication network, such as the Internet. Accordingly, the second communication network interface 420 may comprise, for example, an Ethernet interface. The provision of separate communication network interfaces 416, 420 for different communication networks 112 is particularly useful where the location service center 132 incorporates in a physical device the logical function of a message center 136, and thus has the capability of sending information over the Internet, while remaining a trusted network node with respect to transactions concerning the provision of location related information. The various components of the location service center 132 may communication with one another over an internal communication bus 424.

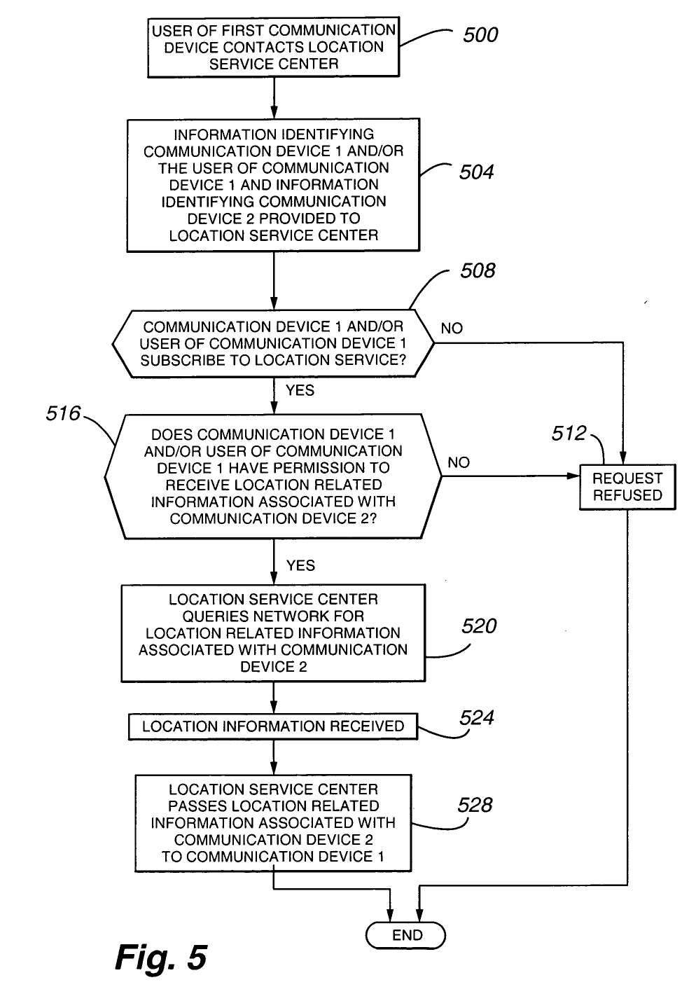

With reference now to FIG. 5, the operation of a system (e.g., system 100 illustrated in FIG. 1) in accordance with an embodiment of the present invention is shown. In particular, FIG. 5 illustrates the delivery of location related information to a requesting communication device 104, 108 in response to a request for such information made by contacting a location service center 132 with a communication device 104, 108. For ease of description, the first communication device 104 will be represented as the device requesting location related information, and the second communication device 108 will be the device about which location related information is requested. However, it should be appreciated that either of the communication devices 104, 108 may initiate contact with the location service center 132 to request location related information regarding the other communication device 104, 108.

Initially, at step 500, the user of the first communication device 104 operates the first communication device 104 to contact the location service center 132. For example, where the first communication device 104 comprises a telephone, contact with the location service center 132 may be initiated by dialing a telephone number associated with the location service center 132. As a further example, for instance where the communication device 104 comprises a general purpose computer or personal digital assistant, contact with the location service center 132 may be made by logging into a web page associated with the location service center 132. As still another example, the first communication device 104 may communicate with the location service center 132 by exchanging messages, such as short message system (SMS) messages.

At step 504, information identifying the first communication device 104 and/or the user of communication device 104, and information identifying the second communication device 108 (i.e. the device about which location related information is desired) is provided to the location service center 132. With respect to the example of a first communication device 104 that comprises a telephone, the required information can be provided in response to voice prompts by the location service center 132. The user may respond by entering the required information using a keypad, by making selections from a menu, or by providing utterances in connection with a voice recognition functionality provided by the location service center 132. With respect to the example of a first communication device 104 comprising a computing device, the required information can be provided by a short message sent from the first communication device 104 to the location service center 132. The content of the short message can be entered by completing a form provided as part of the web page of the location service center 132. As part of the information provided to the location service center 132, the user of the first communication device 104 may specify the particular location related information desired.

Examples of location related information that may be requested include the geographic location of the second communication device 108, for example as a latitude and longitude, a UTM coordinate, a street address, or a city and state. Other location related information that may be requested includes a map of the area surrounding the location of the second communication device 108, weather conditions at the location, services available in the area of the location, and information regarding the specific location of the second communication device, such as the owner of a property or the name of an establishment.

The user of the first communication device 104 may additionally specify a position quality of service that is desired. For example, the user may request location related information derived from location information provided by a global positioning system (GPS) functionality associated with the second communication device 108. Where a high level of positioning accuracy, such as is available in connection with a GPS device, is not available or desired, the user of the first communication device 104 may request and/or be provided with location information derived from non-satellite based triangulation techniques, the location of a cellular base station in contact with the second communication device 108, or information regarding the location of the local switch with which the second communication device is in contact.

As can be appreciated by one of skill in the art, the way in which the position of a communication device 104, 108 is determined will vary depending on the particular features of the communication device and the communication network in connection with which the communication device is operating. For example, a mobile telephone, such as a cellular telephone, may be equipped with a global positioning system (GPS) receiver that can be used to provide precise location information to a base station or mobile switching center with which the communication device is in contact. As a further example, the location of a mobile communication device may be determined using non-satellite based triangulation techniques, for example by determining the angle of a number of base stations having known locations with respect to the communication device. As yet another example, the location of a communication device 104, 108 may be determined, albeit with less precision than with other techniques, from the identity of the switch or base station with which the communication device is in contact. Location information concerning communication devices 104, 108 associated with fixed locations can be obtained by accessing databases such as white pages location databases. The location related information stored in such databases may include information in addition to location information, including the identity of an account holder. As a further example, location related information services provided by a location service center may include services that provide the location of a communication device 104 in various formats or information derived from the location of the communication device 109, such as maps and weather information. At step 508, a determination is made as to whether the first communication device 104 and/or the user of the first communication device 104 is a subscriber of location related information services provided by the location service center 132. For instance, the location service center 132 may determine from conventional caller I.D. information or other provisioned information related to the first communication device 104, whether the first communication device 104 is associated with a subscription to location related information services. Alternatively or in addition, the location service center 132 may determine whether an account number provided by a user of the first communication device 104 corresponds to a valid subscription for services provided by the location service center 132. If the location service center 132 determines that the request for location related information is not made in connection with a communication device 104 and/or a user having a valid subscription, the request is refused (step 512).

If the request for location related information is associated with a first communication device 104 and/or a user of a first communication device 104 having a valid subscription, a determination is made as to whether the first communication device 104 and/or user of the first communication device 104 has permission to receive location related information associated with the second communication device 108 (step 516). Accordingly, such an embodiment of the present invention prevents an unauthorized requestor from receiving location related information associated with the second communication device 108. Examples of scenarios where the user associated with the second communication device 108 may want or consent to the user of the first communication device 104 to have the ability to access location related information associated with the second communication device 108 include situations where the second communication device 108 is provided by the parent or employer of the user of the second communication device 108. Accordingly, parents or employers can ensure that the user of the second communication device 108 is at an authorized location. As another example, users of the first 104 and second 108 communication devices who are friends may consent to the provision of location related information to facilitate meeting the other party in person. If it is determined that the first communication device 104 and/or the user of the first communication device 104 does not have permission to access location related information associated with the second communication device 108, the request is refused (step 512).

If the first communication device 104 and/or user of that device does have permission to receive location related information associated with the second communication device 108, the location service center 132 queries the communication network 112 for location related information associated with the second communication device 108 (step 520). The query placed by the location service center 132 may comprise providing an identifier associated with the second communication device 108 to the communication network 112. In addition, the query placed by the location service center 132 may include an indication of the desired position quality of service.

At step 524, the requested location information is received by the location service center 132. The location service center 132 then passes location related information associated with the second communication device 108 to the first communication device 104 (step 528). The location information received by the location service center 132 may be in any one of a number of formats. For instance, the location related information returned to the location service center 132 may comprise location information in the form a latitude and longitude, the identification of an end office or switch in communication with the second communication device 108, the identification of a wireless base station 124 in communication with the second communication device 108, or a street address associated with the second communication device 108. The location related information delivered to the first communication device 104 may include information derived from location related information (such as location information) received by the location service center 132. In particular, the location related information may be in the form requested by the user of the first communication device 104. For instance, from a location given in the form a latitude and longitude, the location service center may derive a street address by querying an associated or otherwise available database using the location information. As still another example, the location service center 132 may associate a telephone company end office or a base station identification to a general area within which the second communication device 108 is located. As still another example, the location service center 132 may use location related information associated with the second communication device 108 to provide a map or other information related to the location of the second communication device 108, for example in connection with a query made to a database.

The method by which the location service center 132 delivers location related information to the first communication device 104 may vary depending on the nature or capabilities of the first communication device 104, or on the preferences entered by the user of the first communication device 104. For example, voice output generated using a known technique, such as through a text to speech functionality, may be used to provide requested location related information to a first communication device 104 comprising a telephone. Text may be delivered to a communication device 104 having a graphical display or text to speech functionality. For example, short message text may be used to provide requested location related information to a first communication device 104 having short message system capabilities, such as a short message service (SMS) or multi-message service (MMS) enabled telephone or a computing device capable of handling text-based communications. Requested location related information may also be provided as a graphic, in the form of a file as a web page identified by a URL, or in any other multi-media format. As can be appreciated, the particular communication network 1 12 used to deliver the requested location related information may vary depending on the way in which such information is delivered. Thus, a voice delivery system may utilize a PSTN and/or Internet protocol (IP) network (in connection with a VoIP communication), while a text-based communication may utilize a short message system, IP, or packet data communication network 112. Furthermore, where the communication is made over an IP communication network 112, delivery of the message may be through a message center 136 integrated or associated with the location service center 132.

From the description of an exemplary embodiment of the present invention provided in connection with FIG. 5, it should be appreciated that location related information associated with a second communication device 108 may be delivered to a first communication device 104 without completing or attempting to complete a communication link between the first 104 and second 108 communication devices. Instead, an inquiry can be made by contacting a location service center 132 directly, provided that permission to provide such information has been granted.

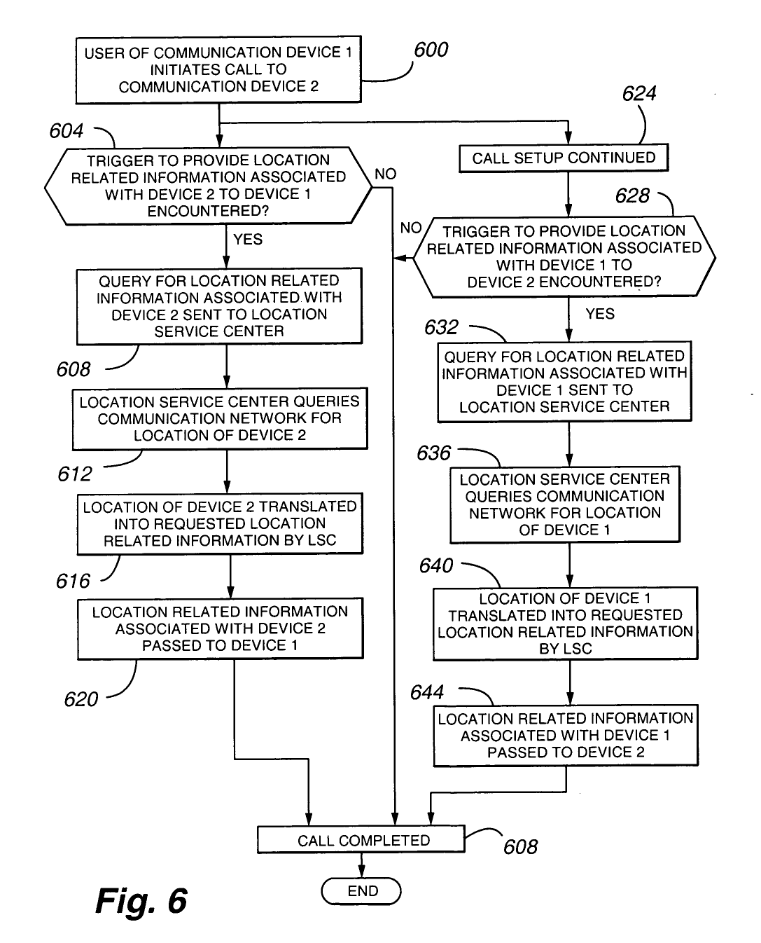

With reference now to FIG. 6, the operation of another embodiment of a system (e.g., system 100) in accordance with an embodiment of the present invention is illustrated. Initially, at step 600, the user of the first communication device 104 initiates a call to the second communication device 108. At step 604, a determination is made as to whether a trigger to provide location related information associated with the second communication device 108 to the first communication device 104 is encountered. If no such trigger is encountered, the call may be completed normally (step 608).

If a trigger to provide location related information is encountered, a query for location related information associated with the second communication device 108 is sent to the location service center 132 (step 608). The location service center 132 then queries the communication network 112 for location related information associated with the second communication device 108 (step 612). In response to the query, the communication network 112 returns the requested location related information, and that information is translated into the form or type of location related information requested as part of the network trigger by the location service center 132 (step 616). The location related information associated with the second communication device 108 is then passed to the first communication device 104 (step 620).

As can be appreciated from the description provided herein, a network trigger may be used to cause the automatic retrieval and delivery of location related information associated with a communication device. Accordingly, such an embodiment of the present invention does not require a user of a first communication device 104 to manually enter information in order to obtain location related information associated with a called communication device (e.g., second communication device 108). According to such an embodiment, the requested position quality of service level may be preprovisioned and delivered as part of the network trigger. Furthermore, it should be appreciated that, prior to querying the communication network 112, the location service center 132 may perform checks to ensure that a valid subscription to the location service center information is associated with the first communication device 104, and that the second communication device 108 has granted permission to the location service center 132 to provide location related information to the first communication device 104.

As can be appreciated from the description provided herein with respect to steps 600-620 of FIG. 6, location related information associated with a called communication device (e.g., the second communication device 108) may be provided automatically to a calling device (e.g., the first communication device 104). In addition, the called device may be provided with location related information associated with the calling device automatically. Thus, after initiation of a call to the second communication device 108 by the first communication device 104 at step 600, and while location related information associated with the second communication device 108 is being collected and delivered, the call set up process may be continued (step 624). At step 628, a determination may be made as to whether a trigger to provide location related information associated with the first communication device 104 to the second communication device 108 has been encountered. This trigger can be encountered in a switch (e.g., switches 116,120) associated with or serving either the first 104 or second 108 communication device. If such a trigger has not been encountered, the call may be completed normally (step 608), for example, while or following the collection and delivery of location related information associated with the second communication device 108.

If a trigger to provide location related information associated with the first communication device 104 is encountered, a query for such location related information is sent to the location service center 132 (step 632). The location service center 132 then queries the communication network 112 for location related information associated with the first communication device 104 (step 636). The location of the first communication device 104 is then translated into the requested location related information (if necessary) by the location service center 132 (step 640). The requested location related information associated with the first communication device 104 is then delivered to the second communication device 108 (step 644). As should be appreciated by one of skill in the art, delivery of the location related information associated with the first communication device 104 may be made by various means or communication networks 112, as discussed above in connection with the delivery of location related information associated with the second communication device 108.

As should also be appreciated by one of skill in the art, the process of obtaining and delivering location related information associated with the second communication device 108, and/or the process of obtaining and delivering location related information associated with the first communication device 104, may be performed in parallel with one another, and also in parallel with the normal call completion process. Therefore, it should be appreciated that an exchange of location related information may be made in connection with communications between communication devices 104, 108.

Furthermore, even if a network trigger to provide location related information associated with a second communication device 108 is not encountered, location related information associated with the first communication device 104 may still be provided to the second communication device 108. Also, even if a network trigger to provide location related information associated with a first communication device 104 is not encountered, location related information associated with the second communication device 108 may still be provided to the first communication device 104. Accordingly, such an embodiment of the present invention permits either or both of a called and calling device 104, 108 to automatically receive location related information associated with another communication device 104, 108.

In addition, it should be appreciated that a trigger to provide location related information regarding a calling device (e.g., first communication device 104) to a called device (e.g., second communication device 108) may be encountered in the originating network. Similarly, a trigger to provide location related information regarding a called device (e.g., second communication device 108) to a calling device (e.g. first communication device 104) may be encountered in the terminating network. Any such trigger may then result in a query to a location service center 132 and the delivery of location related information to the appropriate communication device 104, 108.

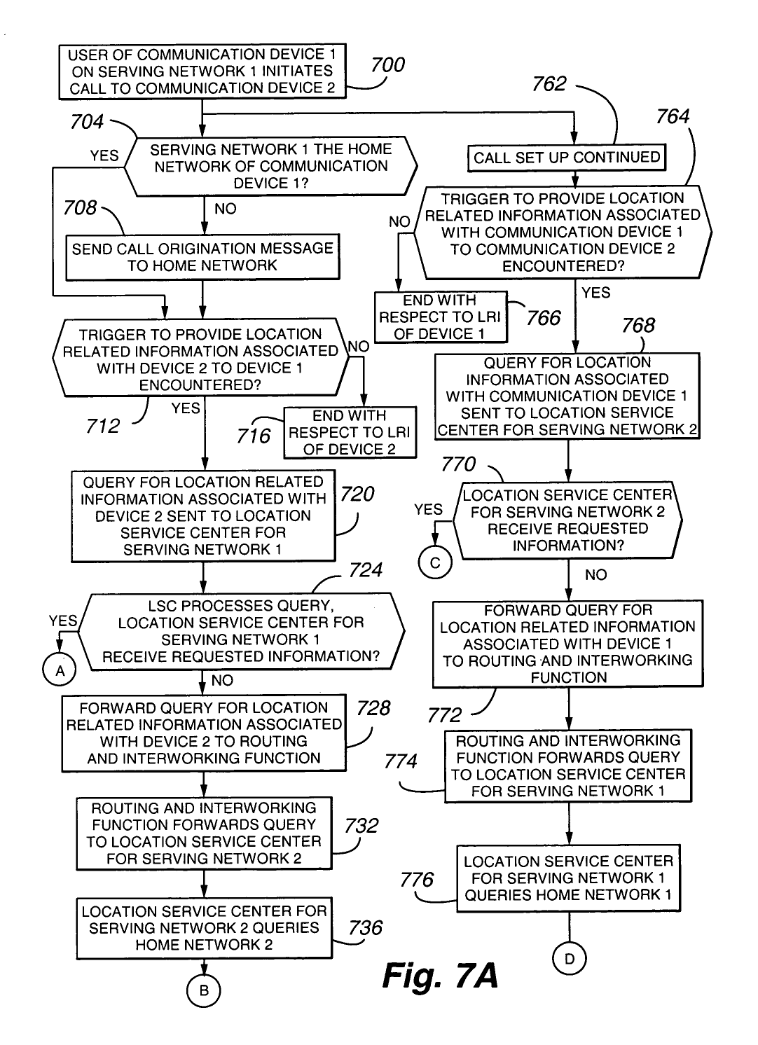

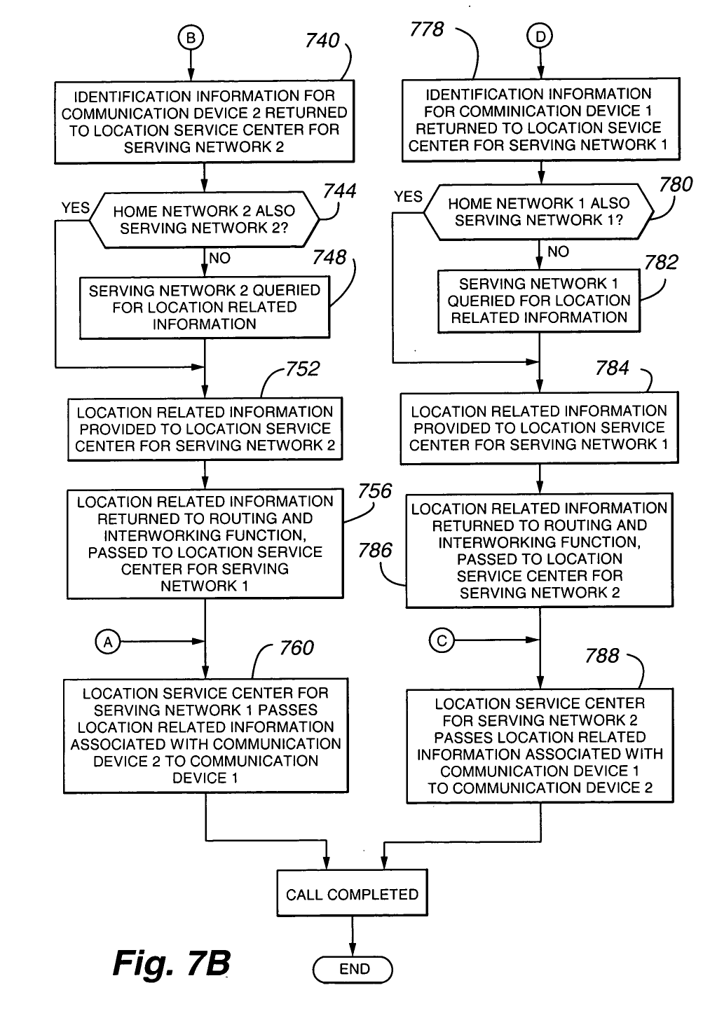

With reference now to FIG. 7A, the operation of a communication system in connection with another embodiment of the present invention is illustrated. In particular, FIG. 7A and B illustrate the operation of a system (e.g., system 200 of FIG. 2 or system 300 of FIG. 3) in obtaining desired location related information regarding a second communication device 108 and delivering such information to a first communication device 104. Such an embodiment of the present invention also illustrates a system capable of delivering desired location related information even when the communication devices 104, 108 are operating in connection with different home and/or serving networks.

At step 700, the user of the first communication device 104 on a first serving communication network 212, 312 initiates the establishment of a communication link (e.g. the user of the first communication device 104 calls the second communication device 108). A determination is then made as to whether the first serving communication network 212, 312 is also the home network of the first communication device 104. If it is determined that the first serving network 312 is not the home network, a call origination message is sent to the first home network 304 of the first communication device 104 (see FIG. 3) (step 708).

After a call origination message has been sent to the first home communication network 304, or if the first serving network 212 is also the home network of the first communication device 104 (see FIG. 2), the system proceeds to step 712. At step 712, a determination is made as to whether a trigger to provide location related information associated with the second communication device 108 to the first communication device 104 has been encountered. If no trigger is encountered, the process ends with respect to obtaining location related information associated with the second communication device 108 (step 716).

If a trigger to provide location related information is encountered, a query for location related information associated with the second communication device 108 is sent to the location service center 132a for the first communication network 212 (or first serving communication network 312) (step 720). At step 724, the location service center 132a processes the query, and a determination is made as to whether the first location service center 132a successfully received the requested location related information. In general, the first location service center 132a processes the query by either querying the first communication network 212, 312, or by first accessing a database to determine whether a query of the first communication network 212, 312 might be successful in obtaining the desired location related information associated with the second communication device 108. If the first location service center 132a is successful in obtaining the desired location related information, the first location service center 132a passes the location related information to the first communication device 104 (step 760).

If a query of the first serving communication network 212, 312 by the first location service center 132a does not result in delivery of the location related information to the first location service center 132a, or if a query of a database indicates to the first location service center 132a that a query of the first serving communication network 212, 312 would not succeed in providing the desired information, a query for location related information associated with the second communication device 108 may be forwarded to a routing and inter-working function 208 (step 728). The routing and inter-working function generally operates to inter-work with all location service centers 132 included within a global location service center 204. In particular, the routing and inter-working function 208 has the intelligence to use identifications, such as directory number, IMSI, MSRN, MSISDN, MDN, IP address, email address, serving network or serving MSC identification, etc., of a user to identify a location service center 132 that should be queried for location related information associated with a particular communication device 104, 108. Accordingly, continuing the present example, the routing and inter-working function 208 is able to determine that a second location service center 132b for second serving communication network 216, 316 should receive the query. Thus, at step 732, the routing and inter-working function 208 forwards the query to the second location service center 132b. The location service center for the second serving communication network 132b then queries the home communication network 216 or 308 for the second communication device 108 (step 736). In response to the query, identification information related to the second communication device 108 is returned to the second location service center 132b (step 740). If the second home communication network is also the serving network for the second communication device 108, the second home communication network 216 will also provide location related information regarding the second communication device to the second location service center 132b (see step 744). If the second home communication network is not the second serving network, the second serving communication network 316 is queried for the desired location related information by the second location service center 132 (step 748). The second serving communication network 316 may be queried by the same location service center 132b that queried the second home communication network 308 or by a separate location service center 132d.

At step 752, the requested location related information is provided to the second location service center 132b. The location related information is then returned to the routing and inter-working function 208, and passed to the first location service center 132a (step 756). The first location service center 132a then passes the location related information associated with the second communication device 108 to the first communication device 104 (step 760). The retrieval of location related information associated with the second communication device 108 and delivery of that information to the first communication device 104 is thus completed.

In general, after the user of the first communication device 104 initiates a call to the second communication device 108 (step 700), the call set up process is continued normally (step 762). As the call set up process extends to the second serving communication network 216, 316 a determination is made as to whether a trigger to provide location related information associated with the first communication device 104 to the second communication device 108 is encountered (step 764). If no such trigger is encountered, the process ends with respect to location related information associated with the first communication device 104 (step 766).

If a trigger is encountered at step 764, a query for location information associated with the first communication device 104 is sent to the second location service center 132b (step 768). At step 770, a determination is made as to whether the second location service center 132b has received the requested information. If the requested information is received, it is delivered to the second communication device 108 (step 788).

If the requested information is not received, the query is forwarded to the routing and inter-working function 208 (step 772). With reference to an internal or external database, the routing and inter-working function 208 may determine that the requested location information might be obtainable from the first communication network 212 or the first home communication network 304. Accordingly, the routing and inter-working function 208 forwards the query to the first location service center 132a (step 774).

At step 776, the first location service center 132a queries the home network 212, 304. In response to the query, identification information for the first communication device 104 is returned to the first location service center 132a (step 778). At step 780, a determination is made as to whether the home network is also the serving network (see first communication network 212 and FIG. 2). If the serving network 312 is not the home communication network 304 (see FIG. 3) the serving communication network 312 is queried for the desired location related information (step 782). The query of the first serving communication network 312 may be performed by the same location service center that queried the home communication network 304, or it may be queried by a separate location service center 132c.

The requested location related information is provided to the first location service center 132a at step 784. The location related information is then returned to the routing and inter-working function 208, and passed to the second location service center 132b (step 786). The second location service center 132b then provides the location related information associated with the first communication device 104 to the second communication device 108 through the serving communication network 216, 316 (step 788).

From the description provided herein in connection with FIGS. 7A and 7B, it can be appreciated that embodiments of the present invention may obtain and deliver location related information associated with a communication device to another communication device when a call or other request for a communication link is made. In particular, through the use of network triggers, such information may be provided according to preprovisioned preferences, and without requiring separate action by a user of a communication device 104, 108. As can be appreciated, the appropriate location service center 132 may validate trigger requests, for example by accessing internal or external databases, prior to fulfilling such requests.

The description provided in connection with FIGS. 7A and 7B also illustrates the ability of a system in accordance with the present invention to provide location related information even when one or a number of communication devices 104, 108 are roaming (i.e. are interconnected to a serving communication network 312, 316 that is distinct from such device's home communication network 304, 308).

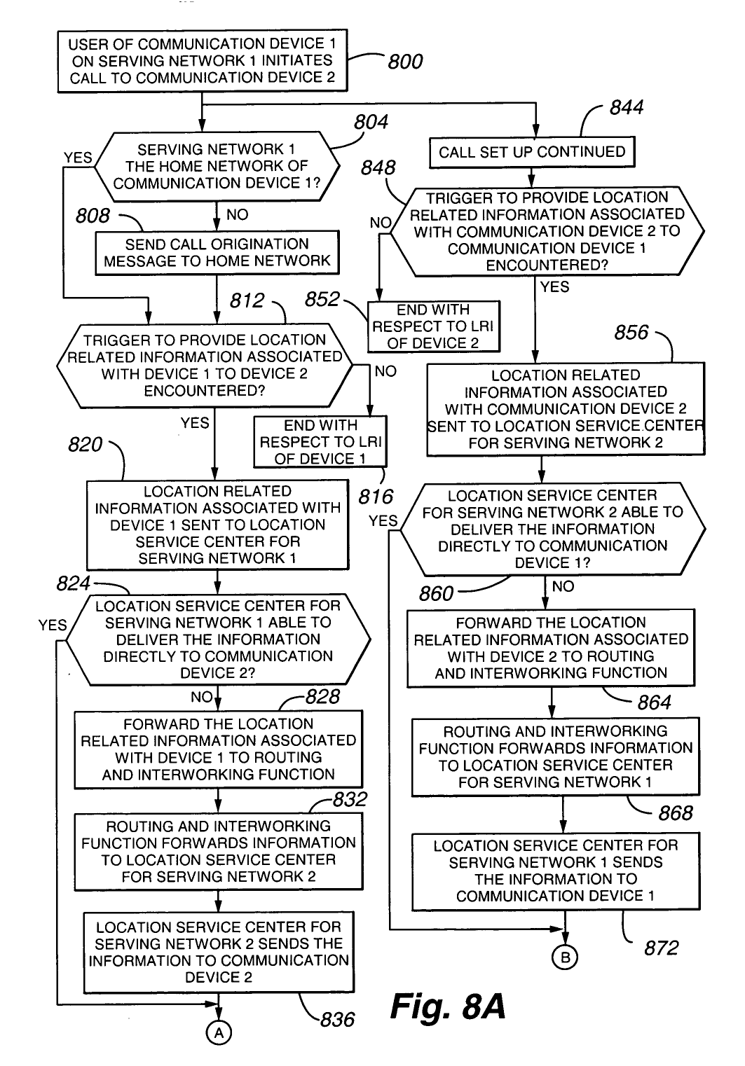

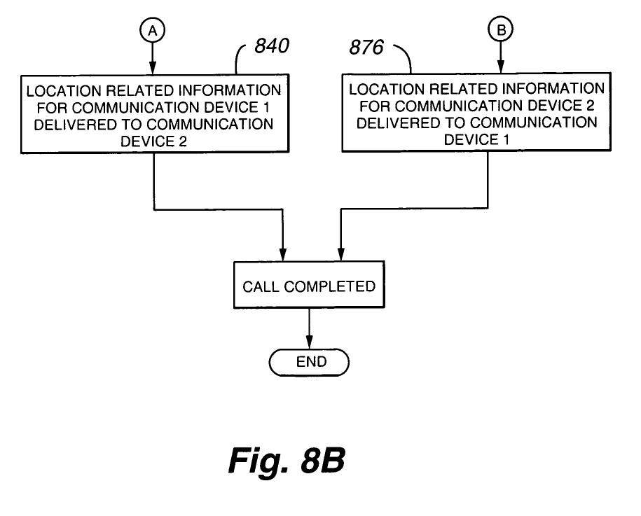

With reference now to FIGS. 8A and 8B, the operation of a system (e.g. systems 100, 200 or 300) according to another embodiment of the present invention is illustrated. In general, FIGS. 8A and 8B illustrate the delivery of location related information in response to network triggers. In addition, the delivery of such information may be between communication devices 104, 108 that are on different communication networks 112, and/or that are roaming.

Initially, at step 800, the user of a first communication device 104 on a first serving communication network (e.g., serving communication network 312) initiates a request for a communication link (e.g. a call) to a second communication device 108. At step 804, a determination is made as to whether the first serving communication network 312 is the home network with respect to the first communication device 104. If the first communication device 104 is being served by a first serving communication network 312 that is distinct from the home communication network 304 for that device, a call origination message is sent to the home communication network 304 (step 808). After the call originating message has been sent, or if the first communication network 212 is both the home and the serving network (e.g., communication network 212), a determination is made as to whether a trigger to provide location related information associated with the first communication device 104 to the second communication device 108 has been encountered (step 812). If no such trigger is encountered, the process ends with respect to the delivery of location related information associated with the first communication device 104 (step 816).

If a trigger is encountered, location related information associated with the first communication device 104 is sent to the location service center 132 (e.g. first location service center 132a) for the serving communication network 112 (e.g. communication network 212 or 312)(step 820).

At step 824, a determination is made as to whether the location service center 132 for the first serving network is able to deliver the location information directly to the second communication device 108. If the location service center 132 is not able to deliver the information directly, such information is forwarded to the routing and inter-working function 208 (step 828). The routing and inter-working function 208 then forwards the location related information to the location service center (e.g. second location service center 132A) for the serving communication network (e.g. communication network 216 or 316) (step 832).

At step 836, the location service center 132 for the second serving network sends the location related information associated with the first communication device 104 to the second communication device 108. The location related information is then delivered to the second communication device 108 for presentation to the user of such device (step 840). The location related information is also delivered to the second communication device 108 if at step 824 it was determined that the location service center 132 for the first serving network was able to deliver the information directly to the second communication device 108.

In general, after the initiation of the request for a communication link at step 800, the normal call set up procedures are continued (step 844). When the call set up process reaches the communication network 112 serving the second communication device 108, a determination is made as to whether a trigger to provide location related information associated with the second communication device 108 to the first communication device 104 is encountered (step 848). If no such trigger is encountered, the process ends with respect to the provision of location related information associated with the second communication device 108 (step 852).

If such a trigger is encountered, location related information associated with the second communication device 108 is sent to a location service center (e.g. second location service center 132b) associated with the communication network 112 serving the second communication device 108 (step 856).

A determination is then made as to whether the location service center is able to deliver the location related information associated with the second communication device 108 directly to the first communication device 104 (step 860). If such direct delivery is not available, the location related information associated with the second communication device 108 is forwarded to the routing and inter-working function 208 (see FIGS. 2 and 3) (step 864). The routing and inter-working function 208 then forwards the location related information to the location service center (e.g. location service center 132a) for the communication network 112 serving the first communication device 104 (step 868). The location service center then sends the location related information associated with the second communication device 108 to the first communication device 104 (step 872).

After the location related information has been sent by the location service center for the first serving network (step 872), or after it has been sent by the location service center for the second serving network (step 860), the location related information for the second communication device 108 is delivered to the first communication device 104 for presentation to the user (step 876).

From the description provided herein, it can be appreciated that the delivery of location related information according to embodiments of the present invention may be accomplished through the use of network triggers. Furthermore, such an arrangement allows location related information to be pushed from one communication device to another.

Although various components of systems in accordance with embodiments of the present invention have been described as distinct entities, such components are not necessarily implemented using distinct physical platforms. For example, various network functions can be incorporated as part of one or more location service centers. In addition, although various of the examples have described a user at a first communication device obtaining location related information associated with a second communication device, the present invention is not so limited. For example, a user of a first communication device may utilize the present invention to obtain location related information associated with the first communication device. Accordingly, a user may obtain precise current location information, maps, directories of nearby services, or other information derived from the user's current location, as determined from the location of the first communication device. For example, a user may initiate contact with a location service center 132 using a communication device 104 to obtain selected location related information associated with the communication device 104.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

1. A system for providing communication device location information, comprising:
a first communication device;
a second communication device;
a location service center node;
a communication network interconnected to said first communication device, said second communication device, and said location service center node, wherein a request for location related information received from a first one of said first and second communication devices regarding a second one of said first and second communication devices is validated.

2. The system of claim 1, wherein said validated request is made by a subscriber to a location determining service.

3. The system of claim 1, wherein said validated request is made by a network node.

4. The system of claim 1, wherein said communication network comprises a plurality of networks.

5. The system of claim 4, wherein said first communication device is associated with a first network and said second one of said first and second communication devices is associated with any one of at least first and second communication networks.

6. The system of claim 1, wherein said location service center node is in communication with a location determining entity.

7. The system of claim 1, wherein said second one of said first and second communication devices comprises a wireless telephone.

8. A location service network node, comprising:
data storage, operable to store at least one of data and application programming;
a processor, operable to execute application programming;
a first communication interface, operable to interconnect said node to a communication network and operable to send and receive location information, wherein location information regarding a first communication device is received from a communication network, and wherein location related information regarding said first communication device is directed to a second communication device.

9. The location service network node of claim 8, wherein said location related information comprises said location information.

10. The location service network node of claim 8, wherein said location information indicates a location of said first communication device in a first format, and wherein said location related information indicates a location of said first communication device in a second format.

11. A method for obtaining location related information, comprising:
initiating a request for location related information associated with a first one of a first communication device and a second communication device;
validating said request;
querying a location determining entity for location information;
providing at least one of said location information and said location related information to a communication device.

12. The method of claim 11, wherein said at least one of said location information and said location related information is provided to a second one of said first communication device and said second communication device.

13. The method of claim 11, wherein said initiating a request comprises requesting a communication link between said first and second communication devices.

14. The method of claim 11, wherein said querying a location determining entity comprises providing said location determining entity with information identifying said first one of said first communication device and said second communication device.

15. The method of claim 14, wherein said information identifying comprises at least one of a telephone number, an Internet protocol address, and an equipment identification number associated with said first one of a first communication device and a second communication device.

16. The method of claim 1 1, wherein said initiating a request comprises using said second one of said first communication device and said second communication device to contact said location determining entity.

17. The method of claim 1 1, wherein said first communication device is a calling communication device.

18. The method of claim 11, wherein said first communication device is a called communication device.

19. The method of claim 1 1, wherein said validating said request is performed in connection with a location service center.

20. The method of claim 11, wherein said location related information comprises at least one of a cell site location, a cell site identifier, a latitude and longitude, and a UTM coordinate.

21. The method of claim 1 1, further comprising:
receiving said location information at a location service center;
generating said location related information from said received location information, wherein said location related information is provided to said communication device initiating said request for said location related information.

22. The method of claim 21, wherein said location related information comprises said location information.

23. The method of claim 21, wherein said location related information comprises at least one of a latitude and longitude, and UTM coordinate, a cell site location, a cell site identifier, a place name, a street address, weather conditions and a map.

24. The method of claim 11, wherein said location information is delivered over a first communication network.

25. The method of claim 24, further comprising:
establishing a communication link between said first and second communication devices over a second communication network.

26. The method of claim 11, wherein each request for location related information is initiated by a subscriber to a location determining service, and wherein said subscriber is associated with said first one of a first communication device and a second communication device.

27. The method of claim 26, wherein said step of validating said request comprises verifying that an account of said subscriber is in good standing.

28. The method of claim 11, further comprising communicating said at least one of said location information and said location related information to a user of said second one of said first communication device and said second communication device.

29. The method of claim 28, wherein said providing at least one of said location information and said location related information to said second one of said first communication device and said second communication device is authorized by a user of said first one of said first communication device and said second communication device.

30. The method of claim 28, wherein said communicating comprises displaying.

31. The method of claim 28, wherein said communicating comprises providing a verbalization.

32. A method of providing communication device location related information, comprising:
receiving a request for location related information associated with a first communication device;
validating said request;
obtaining information comprising a location of said first communication device; and
in response to a valid request, communicating said location related information to at least one of said first communication device and a second communication device.

33. The method of claim 32, wherein said first communication device is one of a calling communication device and a called communication device.

34. The method of claim 32, wherein said request for location related information is received from one of said first and second communication devices.

35. The method of claim 32, wherein said request for location related information is received from a network node.

36. The method of claim 32, wherein said request is received at a location r service center interconnected to said first communication device by a first network.

37. The method of claim 36, wherein said first and second communication devices communicate with one another over a second network.

38. The method of claim 32, further comprising receiving identifying information associated with said first communication device.

39. The method of claim 32, further comprising receiving identifying information related to said second communication device.

40. The method of claim 32, wherein said step of validating said request comprises validating a subscription for location related information associated with said communication device to which said identifying information is to be communicated.

41. The method of claim 32, wherein said step of validating said request comprises validating a subscription for location related information associated with said communication device to which said identifying information is to be communicated.

42. The method of claim 32, wherein said step of validating said request comprises validating a grant of permission by a user of said first communication device to provide said requested location related information.

43. The method of claim 32, wherein said step of receiving a request for location related information associated with a communication device comprises receiving a request for a communication link with a first one of said first and second communication devices from a second one of said first and second communication devices.

44. The method of claim 43, wherein said request for location related information is generated automatically, without manual intervention by a user of said first or second communication device.

45. The method of claim 32, wherein said location related information is communicated to said at least one of said first communication device and said second communication device by at least one of a short message service and a multi-message service.

46. A system for providing location related information associated with a mobile communication device, comprising:
means for determining a location of a first communication device,
means for querying said means for determining a location for a location of said first communication device; and
means for validating a request for location related information associated with said first communication device.

47. The system of claim 46, further comprising means for communicating said location related information to a requester.

48. The system of claim 47, wherein said means for communicating comprises a second communication device.

49. The system of claim 48, wherein said second communication device comprises wireless communication means.
